(19) United States
(12) Patent Application Publication
(10) Pub. No.: US 2012/0030282 A1
(43) Pub. Date: Feb. 2, 2012

(54) SYSTEM, METHOD, AND APPARATUS FOR PROVIDING THIRD PARTY EVENTS IN A SOCIAL NETWORK

(75) Inventors: Bradley Mark Brody, Clive, IA (US); Brittany Rachel Brody, Clive, IA (US)

(73) Assignee: BBE PARTNERS, LLC D/B/A "FAMPUS", West Des Moines, IA (US)

(21) Appl. No.: 13/252,443

(22) Filed: Oct. 4, 2011

Related U.S. Application Data
(63) Continuation-in-part of application No. 12/925,773, filed on Oct. 29, 2010.
(60) Provisional application No. 61/280,180, filed on Oct. 29, 2009.

(51) Int. Cl. G06F 15/16

(52) U.S. Cl. 709/203; 709/204

(57) ABSTRACT

A system, method, and apparatus for providing third party events in a social network are described. Aspects of the disclosure provide for the introduction of events into a social network. These events may be introduced to the social network via one or more event data feeds that are processed by a data funnel. The data funnel extracts and parses event data from the event data feeds for generation of new events for the social network. These events may be vetted or moderated by a third party, such as an administrator or moderator, or they may be automatically verified by the data funnel based upon the data feed from which the event is parsed. Media content may be uploaded and associated to events using a client device.

### CROSS-REFERENCE TO RELATED APPLICATIONS

This application is a continuation-in-part of U.S. patent application Ser. No. 12/925,773 filed on Oct. 29, 2010, which claims priority to U.S. provisional patent Application No. 61/280,180, filed on Oct. 29, 2009. These applications are herein incorporated by reference in their entirety.

### BACKGROUND OF THE INVENTION

Ubiquitous access to the Internet has led to a boom in social networking applications. Users increasingly use these social networks to share personal, social, and business information with one another. Such social networks are generally differentiated by the type of information users share. Many of these networks are defined by the type of information that users share with one another. For example, social networks exist for business and career advancement, sharing of personal media and communications among friends, broadcasting of micro-blog messages, and the like. Such social networks tend to be open communities, allowing any user to join. As such, the user experience is defined by the community that the user chooses to associate with, which may result in a widely different experience from user to user.

20^{th} century philosopher Marshall McLuhan famously coined the phrase “The medium is the message.” Content of a communication is inherently altered by the manner with which that content is transmitted to the consumer. Social networks that allow any user to join and connect with any other user are defined by their openness, with a corresponding effect on the user experience. In an open network, users are left to their own devices to derive utility from the social networking application based on their personal connections with other users. As such, the user may be unaware of events or activities in their geographical area that align with the user's personal interests or that fit into the user's schedule, because the user is not connected with the “right” community. For example, college students that are not socially linked with particular users may not become aware of events or activities that are going on on-campus, even though they might be interested in such events. The lack of an effective search, notification, and calendaring system for such events and activities limit the ability of users to experience events in which they might otherwise have interest.

### BRIEF SUMMARY OF THE INVENTION

A system, method, and apparatus for providing third party events in a social network are described. According to an embodiment, the system, method or apparatus access one or more external event data feeds to receive information describing events that pertain to a particular social network community. The one or more event data feeds are parsed to extract event data attributes associated with a particular event. An event profile for use in the social network is generated using the data-feed-agnostic data structure. The event data attributes associated with the particular event are moderated such that the event profile is not available to users of the social network community until approval.

The event data attributes may be stored in a data-feed-agnostic data structure. Every event profile hosted by the social network may be approved prior to public distribution. The moderating process may also be performed by a superuser. At least one of the event data feeds may be a really simple syndication (RSS) data feed, a user calendar application, a user suggested event, or a website. At least one of the event data attributes may be an event time, an event location, an event type, an event date, or an interest type. The system, method, and apparatus may also associate at least one user interest type with the event profile, and recommend the event to a user, wherein the user is associated with a user profile that is associated with the user interest type.

According to another embodiment, a system, method, and apparatus are provided to upload media content to a social network, using a client device, to navigate an event page associated with a particular event profile. A media upload control embedded within the event page is selected. In response to the selection of the media capture control a media capture mode on the client device is enabled. Media content is captured using the client device enabled with the media capture mode. The media content with an event profile associated with an event are associated with the event page. The media content with is transmitted with an indicator of the event profile such that the media content is associated with the event page.

The system, method, and apparatus can further include determining the location of the client device, transmitting the location of the client device to a remote server, receiving a list of events proximate to the client device, and selecting at least one of the events proximate to the client device from the list for association with the media content.

The media content can be a digital photograph, a video, or an audio file. The indicator of the event profile can be provided by the client device prior to capture of the media content by the client device checking in at an event associated with the event profile.

The event profile page can be generated by accessing one or more external event data feeds to receive information describing events that pertain to a particular social network community, parsing, using a processor, the one or more event data feeds to extract event data attributes associated with a particular event, generating an event profile for use in the social network using the data-feed-agnostic data structure, and moderating the event data attributes associated with the particular event such that the event profile is not available to users of the social network community until approval.

### BRIEF DESCRIPTION OF THE DRAWINGS

FIG. 1 depicts a system diagram of an example of a social networking system in accordance with aspects of the disclosure.

FIG. 2 depicts a block diagram of a client device in accordance with aspects of the disclosure.

FIG. 3 depicts a block diagram of an example data flow for a social networking system in accordance with aspects of the disclosure.

FIG. 4 depicts a flow diagram of an example method for generating an event on a social network in accordance with aspects of the disclosure.

FIG. 5 depicts a flow diagram of an example method for suggesting events using a social network in accordance with aspects of the disclosure.

FIG. 6 depicts a flow diagram of an example method for receiving event data from one or more data feeds in accordance with aspects of the disclosure.

FIG. 7 depicts a flow diagram of an example method for associating media with an event using a client device in accordance with aspects of the disclosure.

FIG. 8 depicts a flow diagram of an example method for associating media with an event using a server in accordance with aspects of the disclosure.

FIG. 9 depicts an illustration of a client device interface for capturing media and associating the captured media with a particular event.

### DETAILED DESCRIPTION

A system, method, and apparatus for providing third party events in a social network are described. Aspects of the disclosure provide for the introduction of events into a social network. These events may be introduced to the social network via one or more event data feeds that are processed by a data funnel. The data funnel extracts and parses event data from the event data feeds for generation of new events for the social network. These events may be vetted or moderated by a third party, such as an administrator or moderator, or they may be automatically verified by the data funnel based upon the data feed from which the event is parsed.

Aspects of the disclosure may also provide a system and method for allowing users to associate media with particular events. For example, a user may upload photos, videos, audio files, or other media to a page corresponding to an event.

Traditional social networks rely on open communities, allowing a widely disparate group of users to socially connect with one another. While such “open” networks provide certain advantages, such as allowing any users to connect with any other users, these networks may fail to provide focus or structure to the user experience.

Certain advantages may be gained by limiting membership in a particular community based on various factors. For example, a particular social network may choose to limit users based upon geographical location (e.g., a particular neighborhood, city, or region) or by affiliation with a particular educational institution (e.g., students/faculty at a particular high school, community college, or university). By limiting membership in the social network to a particular group, the social network may be advantageously focused towards users, events, and activities that are relevant to the particular group (e.g., events occurring on-campus, university sponsored events, etc.). By monitoring the introduction of new events to the group, the focus of the group may be maintained such that collaborative aspects of the social network remain relevant to members of the community that the social network is designed to serve.

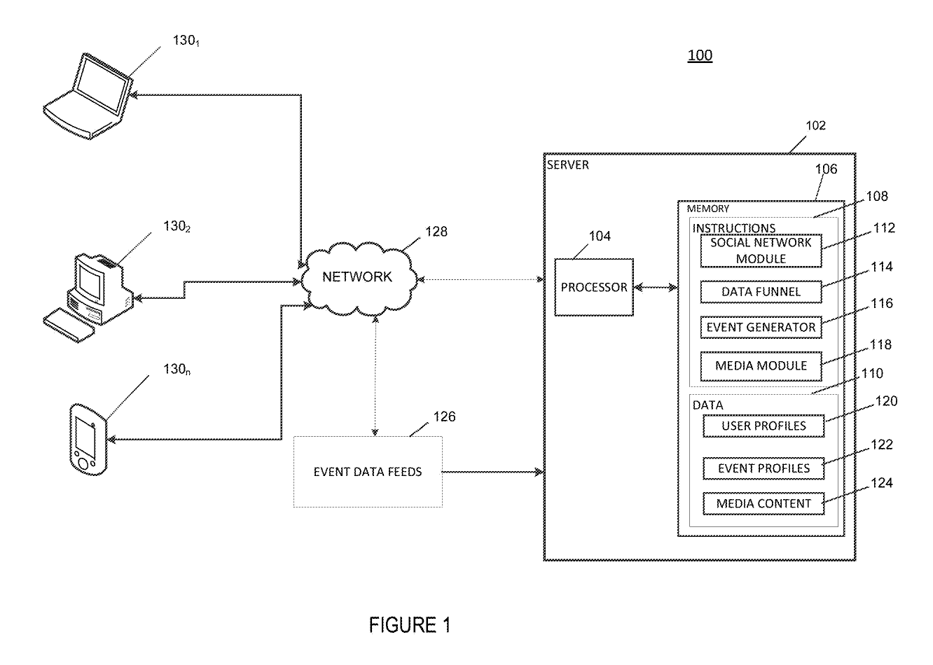

FIG. 1 depicts a system diagram of an example of a social networking system 100 in accordance with aspects of the disclosure. As described above, the social networking system 100 allows for one or more users to interact with other users from a particular community, such as a college campus. The social networking system 100 may provide access to various events and activities that are of interest to users of the community. The social networking system 100 may comprise a server 102 coupled to one or more clients 130 and one or more event data feeds 126 via a network 128. The server 102 executes software to provide social networking services for a particular community. Users (not shown) may interface with the community via the one or more clients 130 in communication with the server 102.

The server 102 may include a memory 106 in communication with a processor 104. The memory 106 may store information that is accessible by the processor 104, including instructions 108 that may be executed by the processor 104, and data 110. The memory 106 may be of any type of memory operative to store information accessible by the processor 104, including a non-transitory computer-readable medium, or other medium that stores data that may be read with the aid of an electronic device, such as a hard-drive, memory card, read-only memory (“ROM”), random access memory (“RAM”), digital versatile disc (“DVD”) or other optical disks, as well as other write-capable and read-only memories. The system and method may include different combinations of the foregoing, whereby different portions of the instructions and data are stored on different types of media.

The instructions 108 may be any set of instructions to be executed directly (such as machine code or bytecode) or indirectly (such as scripts) by the processor 104. For example, the instructions 108 may be stored as computer code on the computer-readable medium. In that regard, the terms “instructions” and “programs” may be used interchangeably herein. The instructions 108 may be stored in object code format for direct processing by the processor 104, or in any other computer language including scripts or collections of independent source code modules that are interpreted on demand or compiled in advance.

The instructions 108 may comprise a social network module 112, a data funnel 114, an event generator 116, and a media module 118. The social network module 112 performs various operations related to functionality of the social network, such as providing hosting of a social networking interface web page, maintenance of user profile data, processing of communication among various users, management of user relationships, and the like. The data funnel 114 receives data from the one or more event data feeds 126. The data funnel 114 parses the event data feeds 126 for event attributes, and extracts and processes these event attributes for generation of events by the event generator for use by the social network module 112. The event generator 116 generates events based on data received either via the data funnel, via users of the social network system, or input by an administrator, moderator, or other “superuser.” The media module 118 receives media, such as photos, videos, audio files, or other data, for hosting and association with one or more users and/or events. Media data received via the media module 118 may be accessed by users of the social networking system 100 via the social network module 112 interacting with a client device 130. Information received from the client devices 130 is typically provided in an anonymous format, where users are allowed to “opt-in” to providing data in this manner. To the extent that user personal information is recorded and/or stored, such data is typically aggregated and anonymized such that individual user information is not available.

Although references to the example social network system 100 described herein describe the social network module 112, the data funnel 114, the event generator 116, and the media module 118 as distinct modules, aspects of the disclosure may also provide similar functionality in a single module, or multiple modules. For example, the data funnel 114 may be integrated with the event generator 116 to receive and generate events for use by the social network system 100, or both elements may be integrated with the social network module 112. Aspects of the instructions 108 may be implemented as software executing on the processor 104 or by various hardware interfaces, such as ASICs, field-programmable gate arrays (“FPGAs”), etc.

The data 110 may be retrieved, stored or modified by the processor 104 in accordance with the instructions 108. For instance, although the architecture is not limited by any particular data structure, the data may be stored in computer registers, in a relational database as a table having a plurality of different fields and listings, Extensible Markup Language (“XML”) documents or flat files. The data may also be formatted in any computer readable format such as, but not limited to, binary values or Unicode. By further way of example only, image data may be stored as bitmaps comprised of grids of pixels that are stored in accordance with formats that are compressed or uncompressed, lossless (e.g., BMP) or lossy (e.g., JPEG), and bitmap or vector-based (e.g., SVG), as well as computer instructions for drawing graphics. The data may comprise any information sufficient to identify the relevant information, such as numbers, descriptive text, proprietary codes, references to data stored in other areas of the same memory or different memories (including other network locations) or information that is used by a function to calculate the relevant data.

Portions of the data 110 may comprise a set of user profiles 120, a set of event profiles 122, and media content 124. The user profiles 120 comprise data related to the users of the social network, such as account credentials, social relationships, personal calendars, and interests. The event profiles comprise data related to events that have been generated for use in the system, such as the date and time of the event, text information describing the event, and types of interests to which the event may appeal. The media content 124 comprises media received via the media module 118, such as photos, audio files, video files, and the like. The media content 124 may be associated with one or more events and/or user profiles.

Although FIG. 1 functionally illustrates the processor 104 and memory 106 as being within the same block, the processor 104 and memory 106 may actually comprise multiple processors and memories that may or may not be stored within the same physical housing. Accordingly, references to a processor, computer or memory will be understood to include references to a collection of processors, computers or memories that may or may not operate in parallel.

In addition, the server 102 may be implemented with additional, different, or fewer components. As one example, the processor 104 and any other logic or component may be implemented with a microprocessor, a microcontroller, a DSP, an application specific integrated circuit (ASIC), discrete analog or digital circuitry, or a combination of other types of circuits or logic.

Logic, such as the instructions 108, may be combined or split among multiple programs, distributed across several memories and processors, and may be implemented in or as a function library, such as a dynamic link library (DLL) or other shared library. The DLL, for example, may store code that implements functionality for a specific module as noted above. As another example, the DLL may itself provide all or some of the functionality of the system.

Although certain advantages are obtained when information is transmitted or received as noted above, other aspects of the system and method are not limited to any particular manner of transmission of information. For example, in some aspects, information may be sent via a tangible medium such as an optical disk or portable drive. In other aspects, the information may be transmitted in a non-electronic format and manually entered into the system.

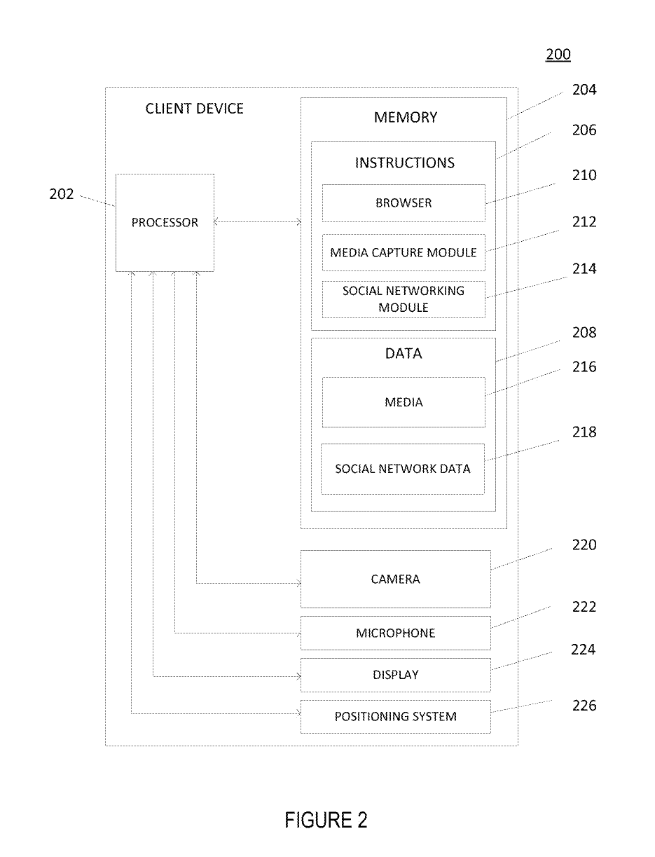

The client devices 130₁, 130₂ . . . 130ₙ may include personal digital assistants (“PDAs”), smartphones, tablet computers, netbooks, laptop computers, desktop computers, cellular phones, or any other devices operable to connect to the network. The client devices 130 may interact with the server 102 via a website interface hosted by the server 102. The client devices 130 may also provide media content to the server 102 for hosting and association with one or more elements of the social network. An example client device is described further with respect to FIG. 2, below.

The event data feeds 126 may be any sort of information stream that contains event data. For example, the event data feeds 126 may comprise one or more RDF Site Summary (“RSS”) feeds, a set of e-mails, calendar data hosted on a website, or any other method of transmitting event data. The server 102 may subscribe to these event data feeds 126, or actively acquire the data (e.g., accessing a website with calendar data at a regular interval). The event data feeds 126 may be processed by the data funnel 114 to extract event data for use by the social network module 112.

The network 128 may be implemented as any combination of networks. As examples, the network 128 may be a Wide Area Network (“WAN”), such as the Internet; a Local Area Network (“LAN”); a Personal Area Network (“PAN”), or a combination of WANs, LANs, and PANs. Moreover, the network 128 may involve the use of one or more wired protocols, such as the Simple Object Access Protocol (“SOAP”); wireless protocols, such as 802.11a/b/g/n, Bluetooth, or WiMAX; transport protocols, such as TCP or UDP; an Internet layer protocol, such as IP; application-level protocols, such as HTTP, a combination of any of the aforementioned protocols, or any other type of network protocol. Although only a few devices are depicted in FIG. 1, it should be appreciated that a typical system may include a large number of connected computers.

Communication between and within the server 102, the network 128, the event data feeds 126, and the client devices 130 may be implemented using one or more interfaces, such as Web Services, or Enterprise Service Bus interfaces. Other examples of interfaces include message passing, such as publish/subscribe messaging, shared memory, and remote procedure calls.

The server 102 may be at one node of the network 128 and be operative to directly and indirectly communicate with other nodes of the network. For example, the server 102 may comprise a web server that is operative to communicate with the client devices 130 via the network 128 such that the server 102 uses the network 128 to transmit and display information to a user via the client devices 130. The server 102 may also comprise a plurality of computers that exchange information with different nodes of a network for the purpose of receiving, processing and transmitting data to the client devices. In this instance, the client devices 130 may be at different nodes of the network than any of the computers comprising the server 102.

FIG. 2 depicts a block diagram of a client device 200 in accordance with aspects of the disclosure. The client device 200 may be an example of one of the client devices 130 described with respect to FIG. 1. The client device 200 provides a user interface for interaction with a social network hosted by a server, such as the server 102 described with respect to FIG. 1. The client device 200 may be any computing device capable of providing such an interface. For example, the client device 200 may be a desktop computer, a laptop computer, a tablet computer, a television, or a smartphone executing a web browser. The web browser may provide an interface to social network data hosted on a server. The client device 200 may be configured similarly to the server 102, with a processor 202 coupled to a memory 204. The client device 200 may also include a camera 220, a microphone 222, a display 224, and a positioning system 226.

As described with respect to the server 102, the memory 204 may comprise a set of instructions 206 and a set of data 208. The processor 202 executes the instructions 206 to control operation of the client device 200. The instructions 206 may comprise a browser 210, a media capture module 212, and a social networking module 214. The browser 210 is operable to provide an interface with a website, such as a social networking website hosted by the server 102. The media capture module 212 provides an interface to the camera 220 and/or microphone 222 for the purpose of capturing media 216 such as audio, video, and/or photographs, and/or storing said media 216 in the data 208. The social networking module 214 may provide an alternate interface to the social network hosted by the server. For example, the social networking module 214 may execute as a special purpose application that is designed to interface with the social network data hosted by the server 102, rather than a general purpose browser

The data 208 may store media 216 as captured by the camera 220 and/or microphone, and social network data 218. The social network data 218 may comprise information received from the server via the browser 210 or social networking module 214 to enable the user to interface with the social network via the computing device 200. For example, the social network data 218 may comprise photographs, user statuses, “friend” requests, and other information commonly provided in a social network environment. The social network data 218 is provided to the user via the browser 210 and/or social networking module 214.

The camera 220 is operable to capture an image to be stored or transmitted by the client device 200. The camera 220 may feature one or more image capture apertures. For example, the camera 220 may feature two apertures, one on the front of the client device 200 and one on the back of the client device 200. The media capture module 212 may allow the user to specify which aperture is used to capture the image, thus allowing the user to, for example, take a picture of himself or herself (e.g., for video chat), or a picture of the environment. The display 226 may function as an image viewfinder to preview the image that will be stored or transmitted. The camera 220 may also be operable to capture video in addition to photographs. In some aspects, the camera 220 may operate in conjunction with the microphone 222 to capture audio and video simultaneously.

The microphone 222 is operable to capture audio information. The microphone 222 may listen for audio data in a variety of frequencies including frequencies that are audible to the human ear and frequencies that are inaudible to the human ear. As described above, the microphone 222 may capture data in conjunction with the camera 220 to create video media that comprises both audio and video. In some aspects, the microphone 222 may be integrated with a voice capture module as commonly used in cellular phones.

The display 224 may display a variety of information to the user, including information associated with the social network system. For example, the display 224 may provide an interface for accessing a user's “home” page on the social network, or viewing the user's schedule. The display 224 may comprise a monitor having a screen, a projector, a television, a computer printer or any other device that is operable to display information.

The positioning system 226 provides location-based services to the client device 200. For example, the positioning system 226 may comprise a global positioning system (“GPS”) receiver for receiving location signals from one or more satellites. The positioning system 226 may determine a location of the client device 200 in various other manners, including, but not limited to wireless network identification, cellular tower triangulation, or other positioning methods.

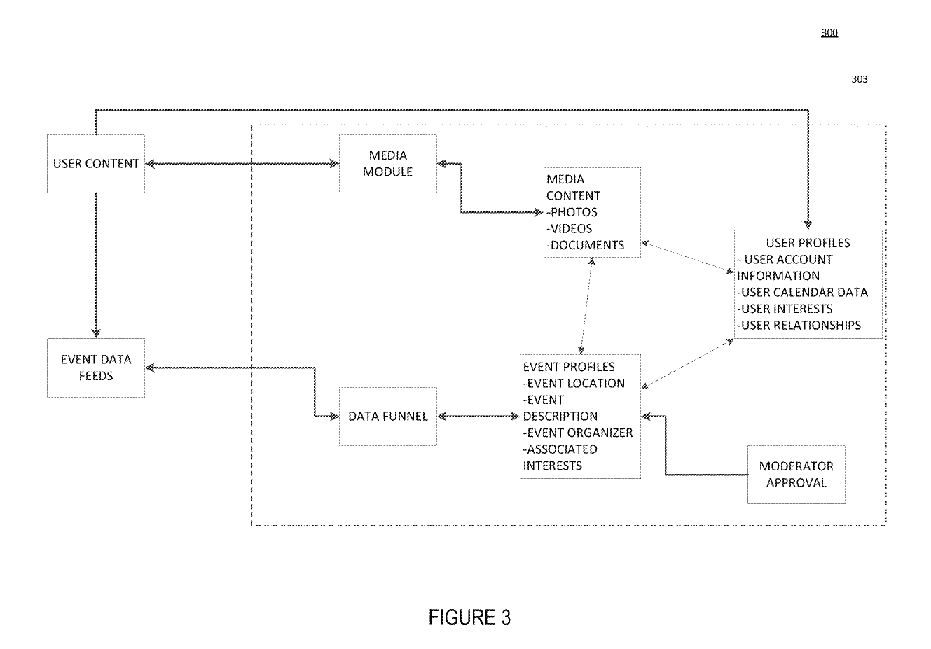

FIG. 3 depicts a block diagram of an example data flow 300 for a social networking system in accordance with aspects of the disclosure. The data flow 300 describes the process by which data flows from a set of user content 301 (e.g., information supplied to the social network via a client device, such as the client devices 130 or the client device 200 described with respect to FIGS. 1 and 2, respectively), and a set of event data feeds 302 to and throughout a social network server 303 for processing.

The user content 301 may comprise any social network content generated by a user. This may include user profile data, user relationship/connection requests, user schedule data, user interest data, and the like. This may also include media content generated by a user, such as photographs, videos, and audio files. Data pertaining to user profiles is processed by the social network server 303 and added to a set of user profile data 310. Media content is processed by a media module 314.

The user content 301 may also comprise events that are generated by users. Events generated in this manner may be treated in the same manner as events that are received via the event data feeds 302.

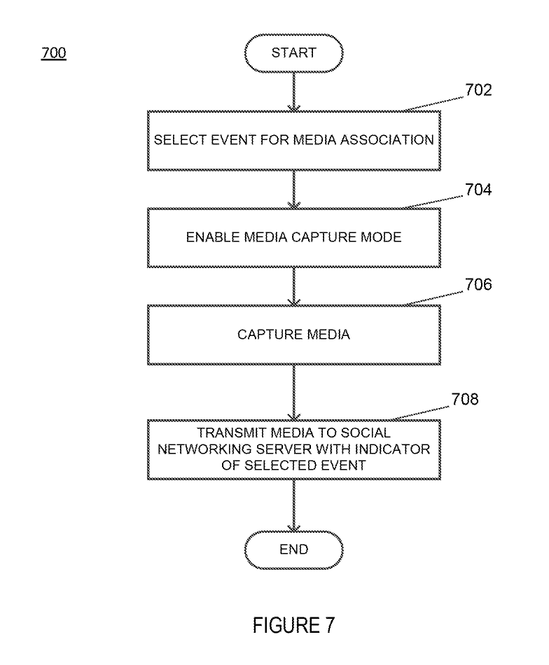

The media module 314 may process media files supplied by a user in a variety of manners. For example, the media module 314 may be configured to receive a data transmission comprising user account credentials and a media file. The media module 314 may verify the user account credentials, and associate the media file with the particular user's account for storage and sharing. The media module 314 may also provide an interface, such as a website rendered on a client device, for uploading the media file and associating the data file with a particular user or event page. In some aspects, the media module 314 may allow a user to navigate to a particular event or user page, and select a media capture configuration option embedded within the event or user page. The configuration option may enable media capture operations on the client device, such that media captured in this manner is automatically uploaded and associated with the particular event or user page. The process by which media files may be captured and associated in this manner is described further with respect to FIGS. 7-9.

Media that is received and processed by the media module 314 is stored as media content 312. The media content 312 may be associated with one or more user profiles 310 and/or one or more event profiles 306.

The event data feeds 302 provide event data to the social network server 303. The event data feeds 302 may provide event data in a variety of manners, such as via RSS feeds, website monitoring, e-mail notifications, interface with calendaring applications, or the like. The event data feeds 302 may also be generated by users, such as by a web form provided on a social network website. Events generated in this manner may be processed in the same way as events generated by external data feeds.

The event data feeds 302 are processed via a data funnel 304. The data funnel 304 parses the event data feeds 302 for particular terms and attributes of events (e.g., date, time, location, title, description, or organizer of the event). These terms and attributes are extracted and stored in data-feed-agnostic data structures. These data-feed-agnostic data structures are used to generate event profiles for use in the social network. In some aspects, newly generated events requiring third-party approval, such as by an administrator, moderator, or other superuser. Newly generated events may also undergo an automated vetting process. For example, if the event is provided by a “trusted” data feed, then the event may be automatically vetted and approved without the need for user intervention.

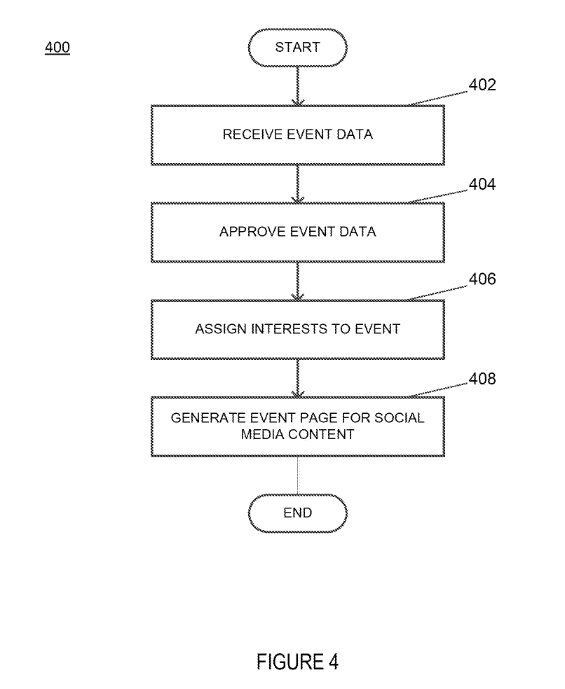

FIG. 4 depicts a flow diagram of an example method 400 for generating an event for use in a social network in accordance with aspects of the disclosure. The method 400 is operable to create and approve a new event based on received event data. By allowing events to be approved prior to “posting” within the social network, a consistent level of quality and appropriateness of content may be maintained. The method 400 also allows for specific interests to be associated with each event, allowing events to be searched and recommended in an efficient manner based on particular user interests.

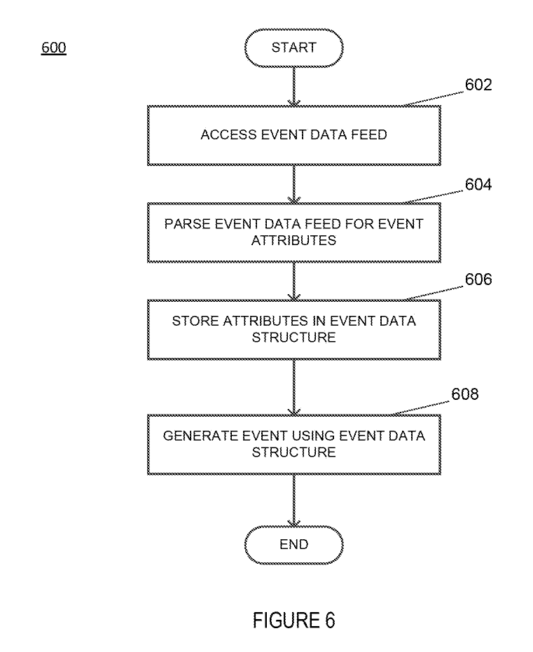

At stage 402, event data is received. As described above with respect to FIGS. 1 and 3, event data may be provided via one or more event data feeds. These event data feeds may be parsed via a data funnel to generate a set of data-feed-agnostic event data. An example method by which the data-feed-agnostic event data may be generated is described further below (see FIG. 6). The data-feed-agnostic event data is presented in a generic format that is pre-determined by the software and/or hardware executing the method 400. As such, the method 400 may easily parse out the date, time, and other event attributes due to the generic format of the event data.

At stage 404, the event data is vetted and approved. As described above with respect to FIG. 3, the event data may be vetted and approved in a variety of manners, such as via a moderator, administrator, or super user, via automatic methods that verify the integrity of the data source, or other methods. Approval of event data prior to posting ensures a high level of quality and relevance to the particular community served by the social network.

At stage 406, particular user interests may be assigned to the event. For example, a football game might be assigned “football,” “tailgating,” or “cheerleading,” interests, because the event would be relevant to users who are interested in football, tailgating, or cheerleading, respectively. The process of assigning interests to an event may be performed manually, such as during the approval process, or automatically, by parsing the event for particular data, such as location or title. The automatic interest assignment process may be dynamically configurable based upon the particular community that the social network serves. For example, a particular college campus might configure interest assignment such that the name of the school athletic team is automatically associated with sporting events.

At stage 408, an event page is generated for use in the social network. The event page functions as a single point for users to upload messages and media for the event. For example, users that are attending a football game may upload pictures from the football game to the event page of the football game. In this manner, the event page functions in a similar manner as a user page, representing a unique node of the social network.

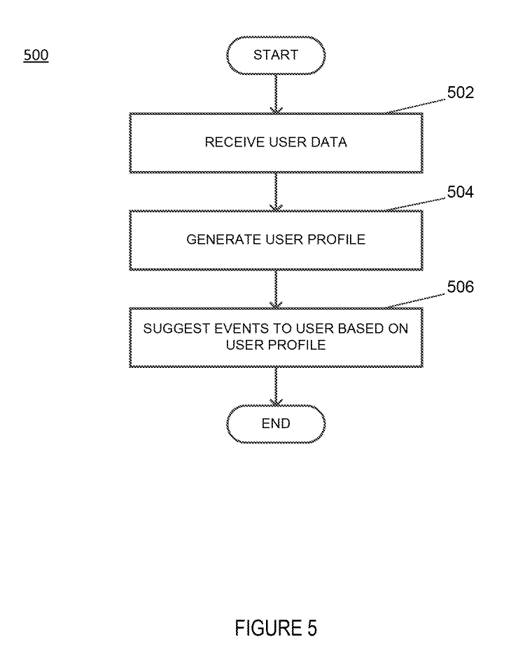

FIG. 5 depicts a flow diagram of an example method 500 for suggesting events using a social network in accordance with aspects of the disclosure. Once events are generated within the social network and interests are assigned to said events, the interest information may be compared to interests associated with user profiles to determine events that may be of interest to particular users.

At stage 502, user data is received. The user data may include user account credentials, the user's name, user contact information, user scheduling information, and user interests. In some aspects, the user data may include information necessary to interface with external systems, such as a university class schedule, user e-mail accounts, personal user calendars, and the like.

At stage 504, a user profile is created based upon the received user data. The user profile stores the user data in a format such that it can be processed in social networking operations. For example, generation of the user profile might typically be accompanied by creation of a user “page” upon which the user can post media content and status updates. The user may also create connections with other users or events for sharing of status updates and media content. These connections may be stored in the user profile as well.

The user profile may also include a user calendar. The user calendar may be manually created by the user, or imported from an external source. For example, where the social network community is a university community, the user profile may query a university class registration system and populate the user's calendar with the user's class schedule. Other data sources may be used to automatically update the user's calendar, such as a user's personal calendar, or a central university server. For example, a user may be identified as a member of a particular varsity sport, and the central university server may provide practice and game schedule information. The user may elect to share the user's calendar with other users.

At stage 506, events may be suggested to the user based on the user profile information. Events may be suggested to the user based on various factors, including the user's location, calendar, interests, and social connections (e.g., events that the user's friends are attending). For example, the social network system may identify events that match the interests of the user and that fit within empty portions of the user's schedule. The social network system may identify these events to the user via personal messages or links to the event page. In this manner, the user may be informed of events that occur within his or her community, without the need to ensure that the user is connected to other users involved with the event, as in traditional social networks.

FIG. 6 depicts a flow diagram of an example method 600 for receiving event data from one or more data feeds in accordance with aspects of the disclosure. The method 600 is operable to extract event data from event data feeds, and to store the extracted event data in a data-feed-agnostic event data structure. Once the event data is stored in the data-feed-agnostic event data structure, an event may be generated for use in the social network based on the event data. Although the instant example describes a process by which new events are generated, the same techniques could be applied to updating an event already present within the social network.

At stage 602, an event data feed is accessed. The event data feed may be accessed in a variety of different manners, such as subscribing to an RSS feed, configuring a website to be refreshed periodically, joining an e-mail listserv, or receiving an event that has been newly generated by a user. Once the event data feed is accessed, event data may be received on a regular, periodic basis from the feed. For example, the data funnel, as described with respect to FIGS. 1 and 3, may periodically poll each event data feed to determine if any new event data has been received.

At stage 604, a set of event data has been received from at least one event data feed, and the set of event data is parsed for event attributes. Event attributes are aspects of the event that are relevant for generation of an event page within the social network. Example event attributes might include the title of the event, the day, date, and time of the event, the organizer of the event, the location of the event, and any particular interests associated with the event. Events may also be associated with particular criteria. For example, a study group for a particular class would only be relevant to users that are enrolled in the particular class. Such criteria might also be parsed from the event data feeds.

The parsing process may take into account variations in the way event data attributes are presented. For example, the date of the event may be presented in any one of the following formats: Jul. 11, 2011 2:30, Jul. 11, 2011 2:30 p, Jul. 11, 2011 2:30 pm, or Jul. 11, 2011, 2:30 o'clock. As part of the parsing process, these date formats are converted into a data-feed-agnostic format. Various rule sets may exist for conversion of different attributes, such as title, description, location, website address, and the like. As new variations for data format are encountered, rules are built related to how to reformat the data into the data-feed-agnostic format.

At stage 606, a data-feed-agnostic data structure is generated based on the parsed event attributes. In some aspects, the data supplied by the event data feeds is supplied in an extensible markup language (“XML”) format, with each attribute contained within appropriate XML tags. In such a case, the data-feed-agnostic data structure may also be an XML data structure with similar tags, but the data formatted into a common format (e.g., the different date formats described above are altered to a single generic format). Once the event attributes are stored in the data-feed-agnostic structure, they may be added to the social network.

At stage 608, a social network event is generated using the data-feed-agnostic data structure. The event may be generated according to the method 400 described above with respect to FIG. 4. In this manner the method 600 provides for conversion of an event into a single data format that is decoupled from the format in which the event was received via the original data feed.

FIG. 7 depicts a flow diagram of an example method 700 for associating media with an event using a client device in accordance with aspects of the disclosure. As described above, event pages provide similar functionality as user profile pages. Users may upload media content to the event page, where the media is displayed to those who access the event page, or who are otherwise associated with the event page (e.g., “friends” with the event). The method 700 provides for efficient creation and upload of such media content.

At stage 702, an event is selected for association with media content. The event may be selected via navigation to a website associated with the event, such as an event profile page hosted by the social network system. In some aspects, the event may be selected from a list of events provided by a remote server. For example, the client device may transmit a current location to the remote server, such as provided by a global positioning system (“GPS”) receiver integrated with the client device. In response, the server may transmit a list of events in the proximity of the client device (e.g., within a 50 foot radius of the client device, within a 100 yard radius, within a 5 mile radius) that are occurring contemporaneously with the transmission of the location. The client device may provide a selection interface allowing the user to select one of the proximate events.

In some aspects, the event may be automatically selected based on where the user has recently checked in. For example, the user may choose to “check in” via their client device at a particular event, thus providing an indication that the user is at a current event or location. When the user performs the “check in” action, media that is subsequently uploaded may be automatically associated with the event at which the user has checked in.

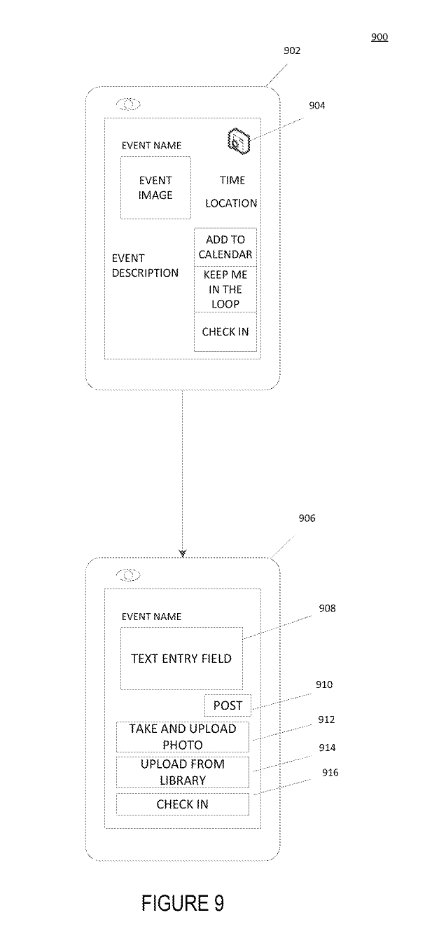

At stage 704, a media capture mode is enabled on the client device. The event page may include an interface option for enabling media capture mode on the client device (see FIG. 9). Selection of a media capture mode enables media capture functionality of the client device, such as enabling the device camera or microphone (e.g., converting the device display to a camera viewfinder and providing a button to capture an image).

At stage 706, media content is captured using the client device. For example, an image may be captured by the camera, or audio by the microphone. The media content is stored in the memory of the client device and prepared for transmission to the social networking server.

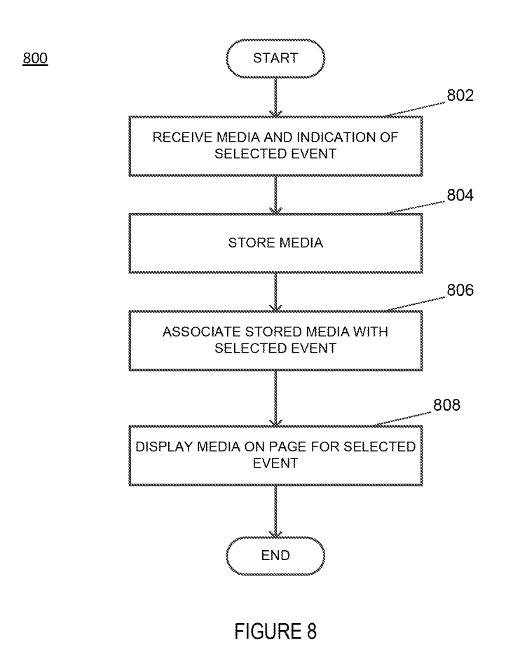

At stage 708, the media content is transmitted to the social networking server along with an indication of the event selected by the user at stage 702. This allows association of the media content with the event the user selected. For example, the user may have selected the event page of a football game that he or she is attending, and enabled the media capture mode using an interface option provided on that event page. The media capture mode allows the user to take a photograph at the game, and upload the photo to the social networking server for association with the football game's event page. The process by which the media content is associated with a particular event page is described further below (see FIGS. 8-9).

FIG. 8 depicts a flow diagram of an example method 800 for associating media with an event using a server in accordance with aspects of the disclosure. The method 800 describes the process by which media content is received from client devices and associated with event pages provided by the social networking server. By providing a streamlined method of uploading media content, users are provided with a simple, transparent method for sharing media content with other users via event pages.

At stage 802, media content is received along with an indication of a particular event. As described above, the media content may be a photograph, audio file, video file, or any other type of media as captured by a client device. The indication of the particular event may be provided by a specific selection operation performed by a user (e.g., upload this photograph to this particular event page), or via other means. As described above, in some aspects the event is selected from a list of proximate events provided to the client device. For example, the client device may provide its current location, and the server may respond with a list of events proximate to the location, that are occurring contemporaneously with the location signal. The client device may allow the user to select an event from the list of events provided by the server. Location information (e.g., global positioning system coordinates) may also be provided along with the media content. The particular event page may be determined based upon events that are happening at the time the upload operation is performed, at the particular geographic location provided with the media content. As another example, a user may be registered as attending a particular event at a particular time. The indication of the particular event may thus be the event that the user that uploaded the content was scheduled to attend at the time of the upload operation.

At stage 804, the media content is stored in memory. In order to associate the media content with a particular event page, the content is stored for later reference, hosting, and/or sharing.

At stage 806, the stored media is associated with the event indicated at stage 802. The association operation may include storing the media content in a data structure associated with the event, by adding a link from the event profile to the stored media content, or any other method of associating the content with the event.

At stage 808, the media content is displayed on the event page to which it is associated. In this manner, media content may be efficiently uploaded and automatically displayed such that any user associated with the event may view the content.

The stages of the illustrated methods described above are not intended to be limiting. The functionality of the methods may exist in a fewer or greater number of stages than what is shown and, even with the depicted methods, the particular order of events may be different from what is shown in the figures and include additional stages or omit stages as shown.

FIG. 9 depicts an illustration of a client device interface 900 for capturing media and associating the captured media with a particular event. The initial interface 902 displays the event page of a particular event hosted by the social networking server. The event page relates to the event and provides information about the event, such as time, location, images associated with the event, the title of the event, and the like. The event page also contains an interface control 904 for enabling media capture operations. Upon selection of the interface control 904 (e.g., by touching the interface control 904 on a touch screen interface), the initial interface 902 changes to the media content upload interface 906.

The media content upload interface 906 allows the user to enter a brief comment 908 for upload with media content. The media content upload interface also includes a set of interface controls for enabling media content capture operations 910, uploading media content from a local library 912, “checking in” at the event 916 (e.g., notifying other users socially connected to the user that the user is at the event), and posting the comment and media content to the event page 916.

Aspects of the disclosure advantageously provide for an efficient way to provide social networking operations for a particular community. The systems, methods, and devices described provide a system that populates a social network with events that are relevant to the particular community. Aspects of the disclosure provide a framework for notifying users of events that are relevant to their interests based on a variety of factors, eliminating the need for specific social connections that is present in other types of social networks. Additional aspects of the disclosure advantageously provide for conversion of external events to a data-feed-agnostic format for easy integration with the social network. Streamlined media content upload operations ensure that users can easily share content for events that they attend.

Although aspects of the disclosure herein have been described with reference to particular aspects, it is to be understood that these aspects are merely illustrative of the principles and applications of the present disclosure. It is therefore to be understood that numerous modifications may be made to the illustrative aspects and that other arrangements may be devised without departing from the spirit and scope of the disclosure as defined by the appended claims. Furthermore, while certain operations and functions are shown in a specific order, they may be performed in a different order unless it is expressly stated otherwise.

As these and other variations and combinations of the features discussed above can be utilized without departing from the disclosure as defined by the claims, the foregoing description of the embodiments should be taken by way of illustration rather than by way of limitation of the disclosure as defined by the claims. It will also be understood that the provision of examples of the disclosure (as well as clauses phrased as “such as,” “e.g.”, “including” and the like) should not be interpreted as limiting the disclosure to the specific examples; rather, the examples are intended to illustrate only some of many possible embodiments.

1. A computer-implemented method for providing events in a social network, the method comprising:
accessing one or more external event data feeds to receive information describing events that pertain to a particular social network community;
parsing, using a processor, the one or more event data feeds to extract event data attributes associated with a particular event;
generating an event profile for use in the social network using the data-feed-agnostic data structure; and
moderating the event data attributes associated with the particular event such that the event profile is not available to users of the social network community until approval.

2. The method of claim 1, further comprising storing the event data attributes in a data-feed-agnostic data structure.

3. The method of claim 1, wherein every event profile hosted by the social network is approved prior to public distribution.

4. The method of claim 1, wherein the moderating process is performed by a superuser.

5. The method of claim 1, wherein at least one of the event data feeds is a really simple syndication (RSS) data feed, a user calendar application, a user suggested event, or a website.

6. The method of claim 1, wherein at least one of the event data attributes is an event time, an event location, an event type, an event date, or an interest type.

7. The method of claim 1, further comprising:
associating at least one user interest type with the event profile; and
recommending the event to a user, wherein the user is associated with a user profile that is associated with the user interest type.

8. A computer-implemented method for uploading media content to a social network, the method comprising:
navigating, using a client device, to an event page associated with a particular event profile;
selecting a media upload control embedded within the event page;
enabling a media capture mode on the client device in response to selection of the media capture control;
capturing media content using the client device enabled with the media capture mode;
associating the media content with an event profile associated with an event associated with the event page; and
transmitting the media content with an indicator of the event profile such that the media content is associated with the event page.

9. The method of claim 8, further comprising:
determining the location of the client device;
transmitting the location of the client device to a remote server;
receiving a list of events proximate to the client device; and
selecting at least one of the events proximate to the client device from the list for association with the media content.

10. The method of claim 8, wherein the media content is a digital photograph, a video, or an audio file.

11. The method of claim 8, wherein the indicator of the event profile is provided by the client device prior to capture of the media content by the client device checking in at an event associated with the event profile.

12. The method of claim 8, wherein the event profile page is generated by a method comprising:
accessing one or more external event data feeds to receive information describing events that pertain to a particular social network community;
parsing, using a processor, the one or more event data feeds to extract event data attributes associated with a particular event;
generating an event profile for use in the social network using the data-feed-agnostic data structure; and
moderating the event data attributes associated with the particular event such that the event profile is not available to users of the social network community until approval.

13. A tangible computer readable medium having instructions stored thereon that, when executed by a processor, cause the processor to perform a method for providing events in a social network, the method comprising:
accessing one or more external event data feeds to receive information describing events that pertain to a particular social network community;
parsing, using a processor, the one or more event data feeds to extract event data attributes associated with a particular event;
generating an event profile for use in the social network using the data-feed-agnostic data structure; and
moderating the event data attributes associated with the particular event such that the event profile is not available to users of the social network community until approval.

14. The tangible computer readable medium of claim 13, further comprising instructions for storing the event data attributes in a data-feed-agnostic data structure.

15. The tangible computer readable medium of claim 13, wherein every event profile hosted by the social network is approved prior to public distribution.

16. The tangible computer readable medium of claim 13, wherein the moderating process is performed by a superuser.

17. The tangible computer readable medium of claim 13, wherein at least one of the event data feeds is a really simple syndication (RSS) data feed, a user calendar application, a user suggested event, or a website.

18. The tangible computer readable medium of claim 13, wherein at least one of the event data attributes is an event time, an event location, an event type, an event date, or an interest type.

19. The tangible computer readable medium of claim 13, further comprising instructions for:
associating at least one user interest type with the event profile; and
recommending the event to a user, wherein the user is associated with a user profile that is associated with the user interest type.

20. A tangible computer readable medium having instructions stored thereon that, when executed by a processor, cause the processor to perform a method for uploading media content to a social network, the method comprising:
navigating, using a client device, to an event page associated with a particular event profile;
selecting a media upload control embedded within the event page;
enabling a media capture mode on the client device in response to selection of the media capture control;
capturing media content using the client device enabled with the media capture mode;
associating the media content with an event profile associated with an event associated with the event page; and
transmitting the media content with an indicator of the event profile such that the media content is associated with the event page.

21. The tangible computer readable medium of claim 20, further comprising instructions for:
determining the location of the client device;
transmitting the location of the client device to a remote server;
receiving a list of events proximate to the client device; and
selecting at least one of the events proximate to the client device from the list for association with the media content.

22. The tangible computer readable medium of claim 20, wherein the media content is a digital photograph, a video, or an audio file.

23. The tangible computer readable medium of claim 20, wherein the indicator of the event profile is provided by the client device prior to capture of the media content by the client device checking in at an event associated with the event profile.

24. The tangible computer readable medium of claim 20, wherein the event profile page is generated by a method comprising:
accessing one or more external event data feeds to receive information describing events that pertain to a particular social network community;
parsing, using a processor, the one or more event data feeds to extract event data attributes associated with a particular event;
generating an event profile for use in the social network using the data-feed-agnostic data structure; and
moderating the event data attributes associated with the particular event such that the event profile is not available to users of the social network community until approval.

25. A system comprising a processor and a memory, the memory having instructions stored thereon that, when executed by the processor, cause the processor to perform a method for providing events in a social network, the method comprising:
accessing one or more external event data feeds to receive information describing events that pertain to a particular social network community;
parsing, using a processor, the one or more event data feeds to extract event data attributes associated with a particular event;
generating an event profile for use in the social network using the data-feed-agnostic data structure; and
moderating the event data attributes associated with the particular event such that the event profile is not available to users of the social network community until approval.

26. The system of claim 25, further comprising instructions for storing the event data attributes in a data-feed-agnostic data structure.

27. The system of claim 25, wherein every event profile hosted by the social network is approved prior to public distribution.

28. The system of claim 25, wherein the moderating process is performed by a superuser.

29. The system of claim 25, wherein at least one of the event data feeds is a really simple syndication (RSS) data feed, a user calendar application, a user suggested event, or a website.

30. The system of claim 25, wherein at least one of the event data attributes is an event time, an event location, an event type, an event date, or an interest type.

31. The system of claim 25, further comprising instructions for:
associating at least one user interest type with the event profile; and
recommending the event to a user, wherein the user is associated with a user profile that is associated with the user interest type.

32. A system comprising a processor and a memory, the memory having instructions stored thereon that, when executed by the processor, cause the processor to perform a method for uploading media content to a social network, the method comprising:
navigating, using a client device, to an event page associated with a particular event profile;
selecting a media upload control embedded within the event page;
enabling a media capture mode on the client device in response to selection of the media capture control;
capturing media content using the client device enabled with the media capture mode;
associating the media content with an event profile associated with an event associated with the event page; and
transmitting the media content with an indicator of the event profile such that the media content is associated with the event page.

33. The system of claim 32, further comprising instructions for:
determining the location of the client device;
transmitting the location of the client device to a remote server;
receiving a list of events proximate to the client device; and
selecting at least one of the events proximate to the client device from the list for association with the media content.

34. The system of claim 32, wherein the media content is a digital photograph, a video, or an audio file.

35. The system of claim 32, wherein the indicator of the event profile is provided by the client device prior to capture of the media content by the client device checking in at an event associated with the event profile.

36. The system of claim 32, wherein the event profile page is generated by a method comprising:
accessing one or more external event data feeds to receive information describing events that pertain to a particular social network community;
parsing, using a processor, the one or more event data feeds to extract event data attributes associated with a particular event;
generating an event profile for use in the social network using the data-feed-agnostic data structure; and
moderating the event data attributes associated with the particular event such that the event profile is not available to users of the social network community until approval.
